(19) United States
(12) Patent Application Publication
(10) Pub. No.: US 2025/0324421 A1
(43) Pub. Date: Oct. 16, 2025

(54) METHODS, ARCHITECTURES, APPARATUSES AND SYSTEMS FOR COMMON DOWNLINK CONTROL CHANNEL IN SINGLE CARRIER WITH FREQUENCY DOMAIN EQUALIZATION

(71) Applicant: InterDigital Patent Holdings, Inc., Wilmington, DE (US)

(72) Inventors: Patrick Svedman, Stockholm (SE); Tariq Elkourdi, Belleville, NJ (US); Ravikumar Pragada, Warrington, PA (US)

(21) Appl. No.: 18/634,513

(22) Filed: Apr. 12, 2024

(51) Int. Cl. H04W 72/20; H04W 56/00

(52) U.S. Cl. CPC H04W 72/20; H04W 56/005

(57) ABSTRACT

Procedures, methods, architectures, apparatuses, systems, devices, and computer program products for using a common downlink control channel. A wireless transmit/receive unit detects, based on at least one received signal, a primary synchronization signal associated with a set of primary synchronization signal parameters, detects, based on the at least one received signal, a secondary synchronization signal associated with a set of secondary synchronization signal parameters, determines a time offset of a control channel signal based on at least one of the set of primary synchronization signal parameters and the set of secondary synchronization signal parameters, determines a time location for reception of the control channel signal based on the time offset, and receives a control channel signal based on the time location.

### BACKGROUND

The present disclosure is generally directed to the fields of communications, software and encoding, including, for example, to methods, architectures, apparatuses, systems directed to common downlink control channel in single carrier with frequency domain equalization.

### SUMMARY

In a first aspect, the present principles are directed to a method at a wireless transmit/receive unit, WTRU, the method comprising detecting, based on at least one received signal, a primary synchronization signal associated with a set of primary synchronization signal parameters, detecting, based on the at least one received signal, a secondary synchronization signal associated with a set of secondary synchronization signal parameters, determining a time offset of a control channel signal based on at least one of the set of primary synchronization signal parameters and the set of secondary synchronization signal parameters, determining a time location for reception of the control channel signal based on the time offset, and receiving a control channel signal based on the time location. In an embodiment, the set of primary synchronization signal parameters may include at least one of a primary synchronization signal symbol rate, a primary synchronization signal duration, and a time difference between two consecutive primary synchronization signals. In an embodiment, the set of secondary synchronization signal parameters may include at least one of a secondary synchronization signal symbol rate, a secondary synchronization signal duration, a secondary synchronization signal sequence length, and a secondary synchronization signal cyclic prefix length.

In a second aspect, the present principles are directed to a wireless transfer/receive unit, WTRU, comprising at least one processor configured to detect, based on at least one received signal, a primary synchronization signal associated with a set of primary synchronization signal parameters, detect, based on the at least one received signal, a secondary synchronization signal associated with a set of secondary synchronization signal parameters, determine a time offset of a control channel signal based on at least one of the set of primary synchronization signal parameters and the set of secondary synchronization signal parameters, determine a time location for reception of the control channel signal based on the time offset, and receive a control channel signal based on the time location. In an embodiment, the set of primary synchronization signal parameters may include at least one of a primary synchronization signal symbol rate, a primary synchronization signal duration, and a time difference between two consecutive primary synchronization signals. In an embodiment, the set of secondary synchronization signal parameters may include at least one of a secondary synchronization signal symbol rate, a secondary synchronization signal duration, a secondary synchronization signal sequence length, and a secondary synchronization signal cyclic prefix length.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates three different SSB-CORESET multiplexing patterns;

FIG. 3 illustrates two successive SC-FDE blocks including a CP and N symbols;

FIG. 4 illustrates an example SC-FDE transmitter and receiver;

FIG. 5 illustrates certain aspects of SC-FDE transmission and reception;

FIGS. 6(a)-6(c) illustrate time multiplexing of PDCCH in a SSS burst;

FIG. 7 illustrates a UE method for common PDCCH reception according to an embodiment of the present principles;

FIG. 8 illustrates an example of an SC-FDE SS with flexible bandwidth and sequence length;

FIG. 9 illustrates use of a narrowband PSS and a separate wideband SSS/PBCH in a SC-FDE system;

FIGS. 10(a)-10(c) illustrate starting times in SC-FDE PSS bursts and SSS bursts;

FIG. 11 illustrates a UE method for time offset determination according to an embodiment of the present principles;

FIG. 12 illustrates a UE method for determination of a number of PDCCH symbols according to an embodiment of the present principles;

FIG. 13 illustrates UE determination of the number of PDCCH symbols according to a first embodiment of the present principles;

FIG. 14 illustrates UE determination of the number of PDCCH symbols according to a second embodiment of the present principles;

FIGS. 15(a)-15(g) illustrate examples multiplexing of PDCCH together with associated SSS/PBCH according to the present principles;

FIG. 16 illustrates an example UE method for determination of DMRS-less PDCCH;

FIG. 17 illustrates multiplexing of PDCCH in an SSS burst based on PBCH absence according to an embodiment of the present principles;

FIG. 18 illustrates a UE method for determination of PDCCH presence based on PBCH absence according to an embodiment of the present principles; and

FIG. 19 illustrates a UE method according to an embodiment of the present principles.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

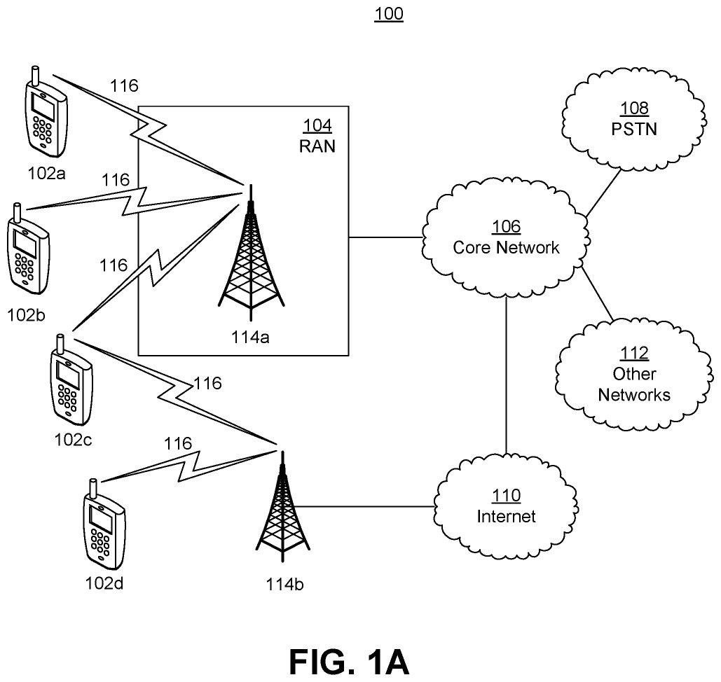

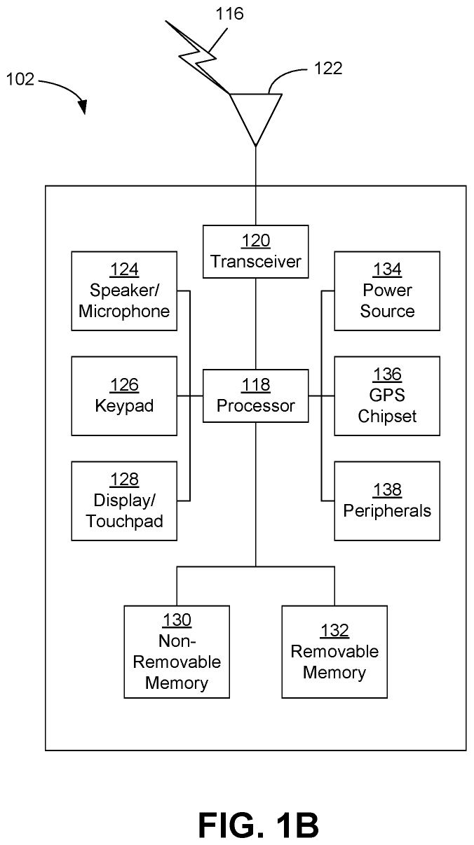

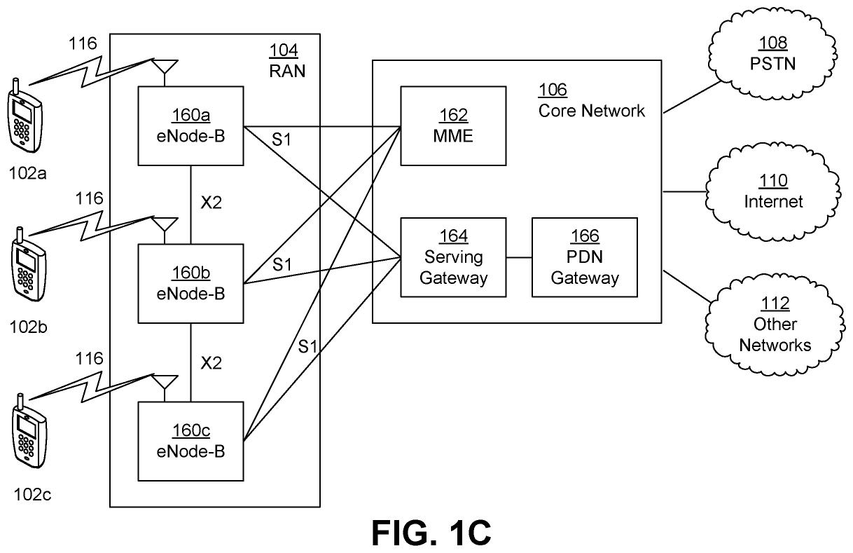

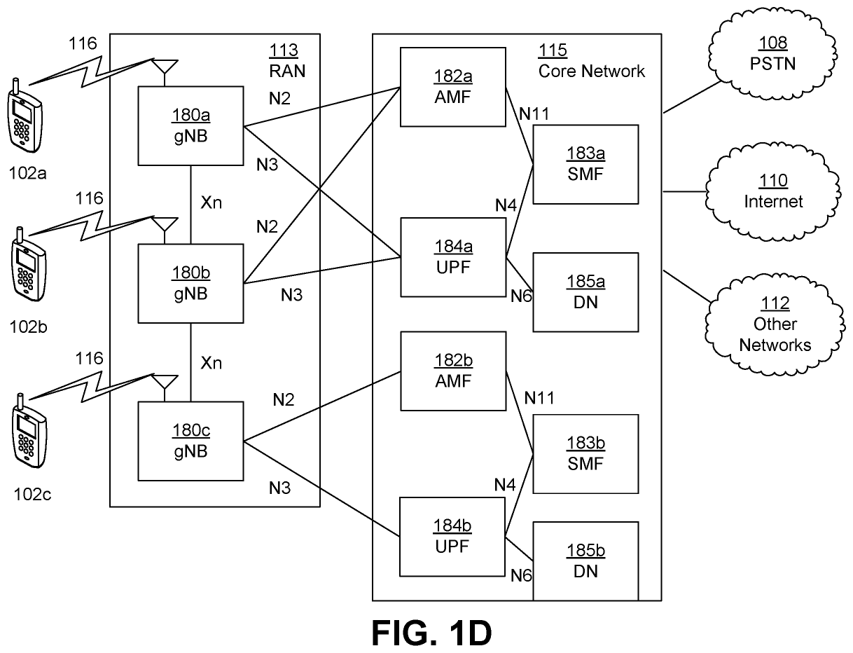

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHZ, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHZ, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In wireless systems like 5G NR (“NR,” hereinafter used as a non-limitative example), when a device starts initial access or decides to transition from idle/inactive state to connected state, it searches for Synchronization Signal (SS)/PBCH Blocks (SSBs) that are transmitted periodically by the network. A SSB includes a Primary Synchronization Signal (PSS), a Secondary Synchronization Signal (SSS) and a Physical Broadcast Channel (PBCH). The SSB occupies four Orthogonal Frequency-Division Multiplexing (OFDM) symbols in the time domain and 240 subcarriers in the frequency domain. The SSBs in a cell are transmitted in a time-multiplexed pattern, e.g., by transmitting different SSBs on different beams in a beam sweeping fashion. The time-multiplexed set of SSBs is sometimes referred to as an SS burst set. The SSBs in the time-multiplexed set are periodically transmitted, with a periodicity of for example 5, 20, or 80 ms. The maximum number of time multiplexed SSBs within a SS burst set can be up to four for frequencies below 3 GHz, eight for frequencies between 3 GHz and 7 GHZ, and 64 for frequencies above 7 GHz (FR2). Time domain location of SSB is different for different SSB numerologies. Each SSB carries a SSB index to indicate the relative location of the SSB to the half frame boundary. The network may transmit only a subset of all supported SSBs. The device can informed of which SSBs are transmitted via a Radio Resource Control (RRC) Information Element (IE) called “ssb-PositionInBurst”.

In NR, there are (as in LTE) three possible PSS sequences. NR PSS is generated by using a Binary Phase Shift Keying (BPSK) modulated m-sequence of length 127. The m-sequence is used to address time/frequency offset the ambiguity problem encountered in the Zadoff-Chu sequence used in LTE. PSS is used for coarse time/frequency synchronization. PSS is also one of the factors determining Physical Cell ID. A UE implementation may run parallel and/or sequential correlators to detect one of the three possible PSS sequences, with different time and frequency offsets. If a peak is detected at a particular time/frequency, the UE may assume which PSS is transmitted and a corresponding SSB time/frequency offset.

There are 336 possible SSS sequences in NR. After detecting PSS, at least the coarse timing and frequency of SSS is known to the UE, given that it may assume that PSS and SSS are transmitted on the same antenna port. If a SSS is detected, a physical cell ID (PCI) can be calculated. The PCI is needed to demodulate the PBCH. Using PCI, the UE can determine the frequency-domain position of the Demodulation Reference Signal (DMRS) in the PBCH.

An SSB index may be provided to the UE in two parts: an implicit part encoded in the PBCH DMRS and in the scrambling applied to the PBCH, and an explicit part included in the PBCH payload. The PBCH depends on the SSB index. The UE may detect which of the (e.g., 4 or 8) possible versions of DMRS sequences that is used to determine the one was sent for a particular received SSB. The UE may decode the PBCH to obtain a Master Information Block (MIB). The MIB may carry three bits for SSB index which the UE uses, along with knowledge of which DMRS sequence was transmitted, to determine up to 64 SSB indexes, in case of up 64 SSBs. The MIB also contains parameters required to receive System Information Block 1 (SIB1) (carried on Physical Downlink Shared Channel, PDSCH) which is needed for the random access process. Once the SIB is decoded, the UE has information required for the Random Access Channel (RACH).

The synchronization signals can be used for a number of purposes such as acquisition and cell search (e.g., acquisition of frequency and symbol synchronization to a cell, and acquisition of frame timing of the cell, i.e. to determine the start of the downlink frame), determination of the physical-layer cell identity (PCI) of the cell, acquisition and demodulation of system information channels and associated DMRSs (PBCH, Physical Downlink Shared Channel, PDSCH, for system information and associated DMRSs), acquisition and demodulation of paging information (e.g., PDSCH for paging and associated DMRSs), Radio Resource Management (RRM) measurements in support of L3 mobility, cell search in idle mode and cell re-selection, handover in RRC connected mode, and radio link monitoring (RLM) procedures, and beam management measurements (i.e. PHY measurements) in support of beam management procedures, including Quasi Colocation (QCL) and Transmission Configuration Indication (TCI) framework.

In NR, an ‘acceptable cell’ is a cell on which a UE may camp in idle/inactive mode to obtain limited service, e.g., to originate emergency calls, and receive notifications from the Earthquake and Tsunami Warning System (ETWS) and the Commercial Mobile Alert System (CMAS). An acceptable cell fulfils a minimum set of requirements, such as not being barred, and a cell selection criterion. The cell selection criterion requires that the cell received power and cell quality are sufficiently high.

Further, a ‘suitable cell’ is a cell on which a UE may camp in idle/inactive mode for normal service such as to receive system information, tracking area information, registration area information, paging and notification messages, etc., from the network, as well as to initiate transfer to connected mode. A suitable cell fulfils the set of requirements for an acceptable cell, as well as additional requirements, such as that the cell is a part of a mobile network that is selected or registered by the UE.

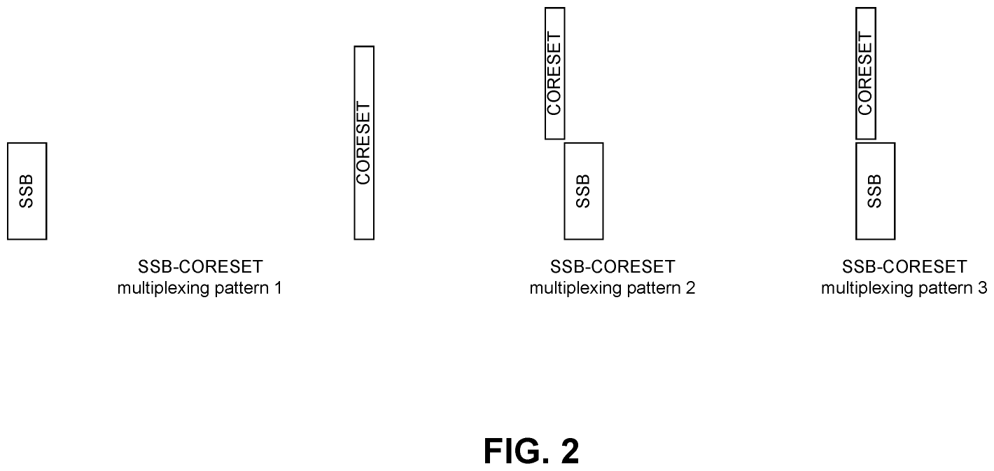

Upon SSB and MIB reception, the UE may monitor a common ‘CORESET’ (CORESET #0) for Type0-PDCCH CSS set (search space #0). There are three different SSB-CORESET multiplexing patterns defined, as illustrated in FIG. 2. In multiplexing pattern 1, the associated SSB and CORESET are time-multiplexed, e.g., in a different subframes or frames. In multiplexing pattern, 2, the associated SSB and CORESET are in the same slot, but not the same symbol. In multiplexing pattern 3, the CORESET is frequency multiplexed with the associated SSB.

The MIB includes a 4-bit configuration index for CORESET #0 and a 4-bit configuration index for search space #0. In NR, the UE determines the SSB-CORESET multiplexing pattern based on the 4-bit configuration index for CORESET #0, the SSB subcarrier spacing (SCS), and the PDCCH subcarrier spacing.

For example, if the 4-bit configuration index=5, the UE determines the following multiplexing patterns: SSB-CORESET multiplexing pattern 1 if SSB SCS=30 kHz and PDCCH SCS=30 kHz, SSB-CORESET multiplexing pattern 2 if SSB SCS=240 kHz and PDCCH SCS=120 kHz, and SSB-CORESET multiplexing pattern 3 if SSB SCS=120 kHz and PDCCH SCS=120 kHz.

In other words, the UE cannot always determine the SSB-CORESET multiplexing pattern based on only the MIB content. The UE determines the PDCCH subcarrier spacing based on the frequency range and a 1-bit parameter in the MIB.

Single carrier with frequency domain equalization (SC-FDE) uses a single carrier waveform that, compared to OFDM, exhibits improved Peak to Average Power Ratio (PAPR) characteristics, robustness to phase noise and low-resolution Analog to Digital Conversion (ADC)/Digital to Analog Conversion (DAC). Although both OFDM and SC-FDE use a single DFT block and a single Inverse DFT (IDFT) block (with the same overall complexity), the SC-FDE IDFT operation happens at the receiver. The higher power efficiency of the SC-FDE transmitter can translate into an increase in cell coverage area. Due to its single carrier nature, SC-FDE does not provide means for frequency multiplexing (within an SC-FDE carrier) although other multiplexing means (time, space, polarization, etc.) are still applicable.

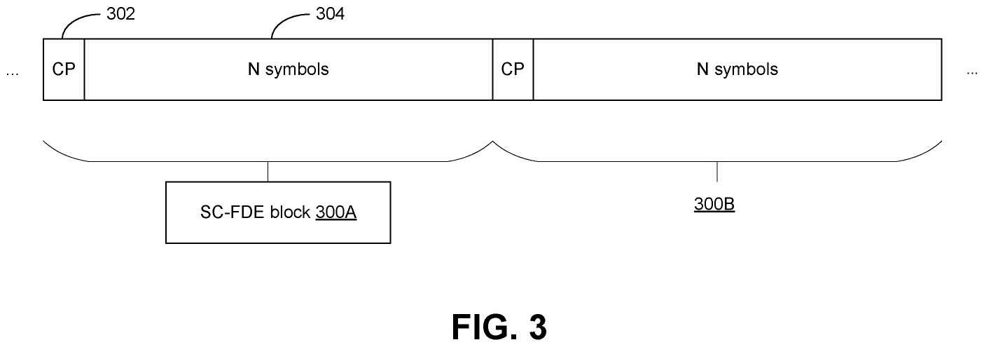

To enable frequency domain equalization using DFT/IDFT, similar to OFDM, SC-FDE systems may typically use a cyclic prefix (CP) with a duration that is longer than the channel. FIG. 3 illustrates two successive SC-FDE blocks 300A, 300B, each including a CP 302 and N symbols 304 (only illustrated for SC-FDE block 300A).

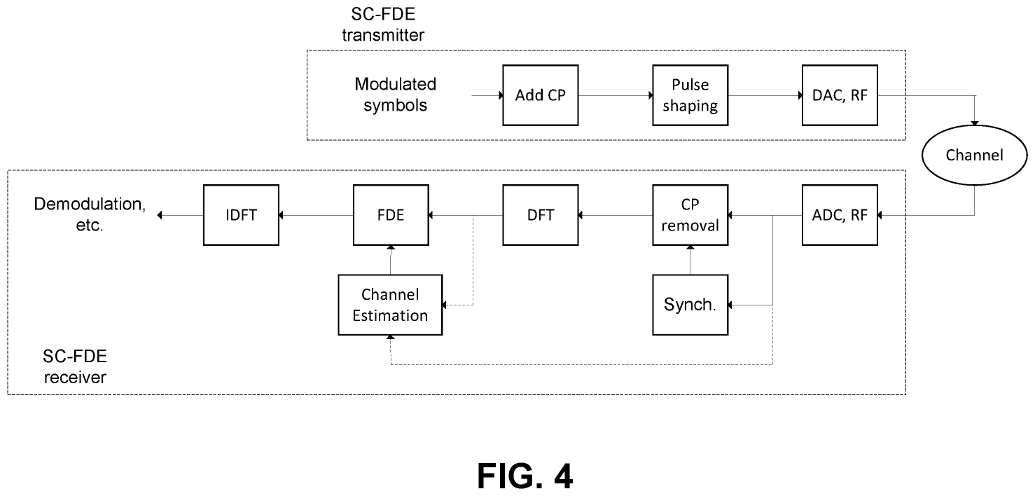

In OFDM, demodulation and detection are performed in the frequency domain. In SC-FDE, demodulation and detection are performed in the time domain, after FDE. An example SC-FDE transmitter and receiver is illustrated in FIG. 4. The DFT and IDFT size should preferably match the number of symbols in the SC-FDE block (i.e., N in FIG. 3).

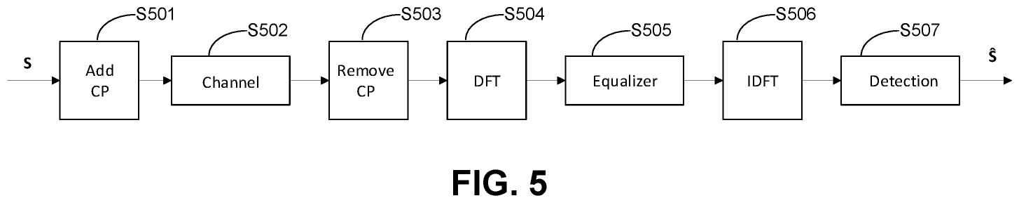

FIG. 5 illustrates certain aspects of SC-FDE transmission and reception. At the SC-FDE transmitter, a group of log₂ M data bits are mapped into a complex symbol, s, in an M-ary complex constellation. Then, N symbols are grouped into blocks and sent to the encoder. A cyclic prefix (CP) is added (S501) to each block, by prefixing a copy of its last N_CP symbols. This prevents Inter-block interference (IBI) but wastes bandwidth and is energy inefficient. It introduces short term periodicity that makes the linear convolution of the channel impulse response look like a circular convolution. Circular convolution in the time domain is useful as it translates into multiplication in the frequency domain. The CP extended blocks are fed to a parallel to serial converter, a digital-to-analog convertor, frequency up-convertor and a filter before it gets transmitted over the wireless channel (S502). At the receiver, the signal is fed to a frequency down-converter, a filter and analog-to-digital converter. The output sequence of samples is grouped into blocks again. For each block, CP is discarded (S503), and the remaining samples are sent to a DFT block for conversion (S504) to the frequency domain. Then, a frequency domain equalizer (FDE) is used (S505) to compensate for channel distortion. The output symbols are fed to an IDFT block for conversion (S506) to the time domain. The time domain symbols may be fed to a detector (S507), resulting in the detected symbol ŝ.

The SC-FDE transmitted signal bandwidth is proportional to the symbol rate. The SC-FDE block duration depends on the symbol rate, assumed receiver DFT/IDFT size, and CP. The SC-FDE block duration may be given by Equation 1:

$$block duration = \frac{DFT size}{symbol rate} + CP duration \qquad ( Eq . 1 )$$

The CP duration should accommodate communication channel time dispersion, time synchronization errors, etc. It consists of an integer number of symbols that is less than the assumed receiver DFT/IDFT size. For a fixed CP duration (in seconds) and DFT/IDFT size, CP overhead grows with symbol rate, i.e., with shorter SC-FDE block duration.

As can be seen, DL transmission based on the SC-FDE waveform has various benefits compared to DL transmission based on the CP-OFDM waveform. An essential part in communication systems is the design of DL synchronization signals with consideration to impacts on UE and network power consumption, synchronization performance, and resource overhead in support of initial access procedures (e.g. cell acquisition, system information reception), etc. A synchronization signal framework for SC-FDE may comprise separate PSS bursts and SSS/PBCH bursts, wherein the PSS symbol rate the SSS/PBCH symbol rate may be different.

In NR, the common PDCCH (CORESET/SS #0) may be time or frequency multiplexed with the associated SSB. Frequency multiplexing is beneficial since the same DL Tx beam is used for both SSB and PDCCH. Time multiplexing of PDCCH next to the associated SSB is beneficial, especially for very high numerologies since beam switching can be avoided. In the SC-FDE synchronization signal framework, it would be interesting to have a solution allowing efficient multiplexing of the common PDCCH and allowing the UE to determine the common PDCCH resources.

A solution of the present principles will now be described briefly before going into details. A common PDCCH, e.g., for reception of SI, RAR, paging, etc., is beneficially time-multiplexed together with the SC-FDE SSS/PBCH. This is like how the common CORESET #0 can be time-frequency multiplexed in NR where the UE determines multiplexing pattern 1/2/3 based on the SSB subcarrier-spacing. However, the time-multiplexing together with the SSS/PBCH is only possible if the gap between subsequent SSS/PBCH is sufficiently large to fit the PDCCH. If not, the PDCCH needs to be multiplexed outside the SSS burst.

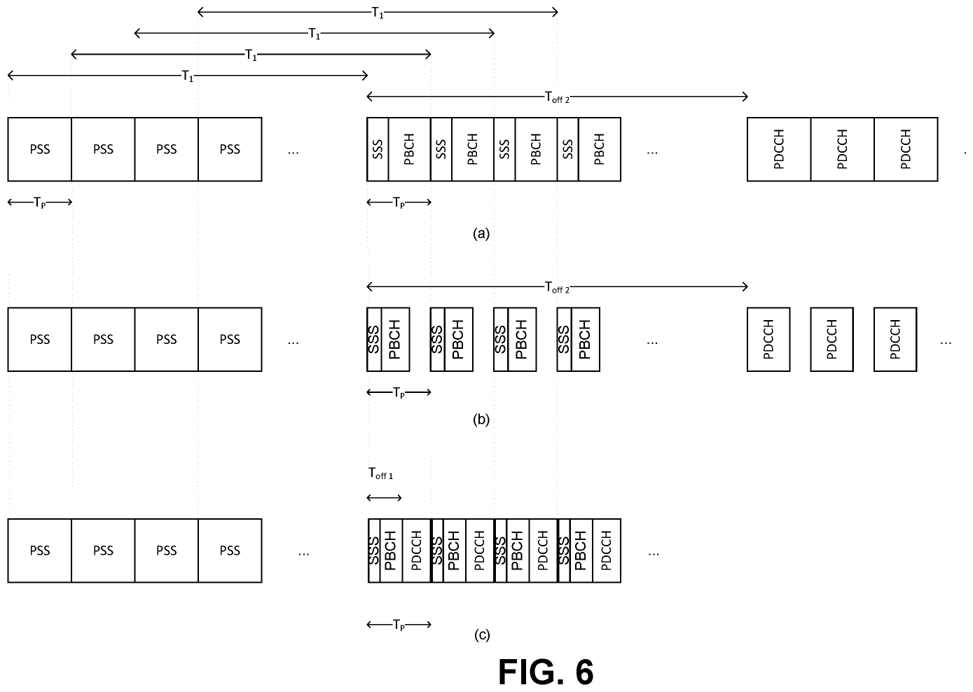

FIGS. 6(a)-6(c) illustrate time multiplexing of PDCCH in the SSS burst (with a first time offset T_{off 1} in FIG. 6(c)) and time multiplexing of PDCCH outside the SSS burst (with a second time offset T_{off 2} in FIG. 6(b) and FIG. 6(a)). A PDCCH that is time multiplexed in the SSS burst may have a time offset (e.g., T_{off 1}) smaller than the duration of the SSS burst. Typically, the PDCCH would be multiplexed somewhere between two consecutive SSS transmissions. In FIG. 6(c), the time offset T_{off 1} is smaller than the time offset between two consecutive SSS transmissions T_{P}, which means that the UE may receive the PDCCH shortly after the associated SSS, but prior to the subsequent SSS. A PDCCH that is time multiplexed outside the SSS bursts, on the other hand, may have a time offset (e.g., T_{off 2}) that is larger than the duration of the SSS burst. This may imply that the UE may receive the PDCCH associated with the first SSS in the SSS burst after the last SSS in the SSS burst, as shown in FIGS. 6(a) and 6(b). In FIGS. 6(a) and 6(b), the duration of the PDCCH is equal, or similar, to the duration of the SSS/PBCH in the SSS burst. However, the PDCCH duration may be different from the SSS/PBCH duration, in various embodiments.

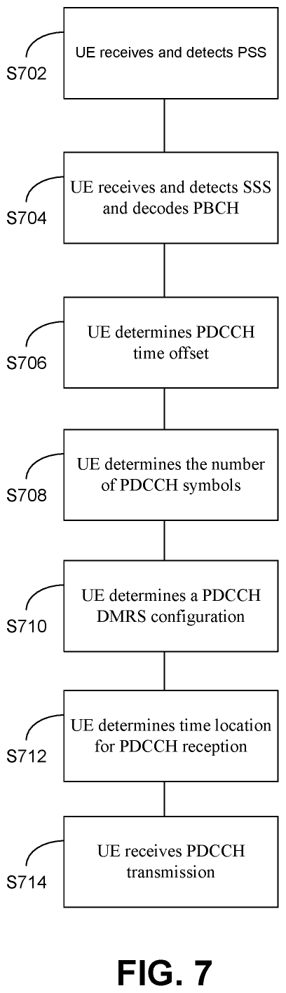

FIG. 7 illustrates a UE method for common PDCCH reception according to an embodiment of the present principles.

In step S702, the UE receives and detects a PSS with a set of PSS parameters. Example PSS parameters include PSS symbol rate, PSS duration, and time difference between two consecutive PSSs in a PSS burst (e.g., TP in FIG. 6(a)-FIG. 6(c)).

In step S704, the UE receives and detects a SSS and decodes a PBCH. The SSS/PBCH are associated with the PSS, and the SSS/PBCH has a set of SSS/PBCH parameters. Example SSS/PBCH parameters include SSS symbol rate, PBCH symbol rate, SSS/PBCH duration, PBCH presence/absence, and SSS/PBCH index.

In step S706, the UE determines a PDCCH time offset at least based on the set of PSS parameters and/or the set of SSS/PBCH parameters.

In one example, the time offset is determined based on the ratio between the SSS/PBCH symbol rate and the PSS symbol rate. The UE determines the time offset as a first value if the ratio is above or equal to a threshold, and as a second value if the ratio is below a threshold.

In another example, the time offset is determined based on the difference between a time difference between two consecutive PSSs in a PSS burst (T_{P} in FIG. 6) and the SSS/PBCH duration. The UE may determine the time difference between two consecutive PSSs as the minimum time difference between two consecutive PSSs for the PSS symbol rate, e.g., based on a pre-defined PSS burst structure for the PSS symbol rate. The UE may determine the time difference between two consecutive PSSs based on a SSS/PBCH index.

In yet another example, with longer PBCH periodicity than SSS periodicity, the time offset is determined such that a PDCCH time location is in an SSS/PBCH burst without PBCH.

The determination of the time offset, e.g., a part of the time offset, may also depend on a parameter in the decoded PBCH, e.g., a MIB parameter.

In step S708, the UE determines the number of PDCCH symbols based on for example the available gap duration for the determined time offset, minimum CP duration, supported DFT-sizes, etc. The UE may also determine the PDCCH symbol rate, which also impacts number of PDCCH symbols.

In step S710, the UE determines a PDCCH configuration based on the PDCCH time offset.

In step S712, the UE determines a time location for PDCCH reception based on the determined time offset. The time location for PDCCH reception may for example be determined as the time location of the detected SSS plus the time offset, e.g., the first time offset. The time location for PDCCH reception may for example be determined as the beginning of a radio frame plus the time offset, e.g., the second time offset.

In step S714, the UE receives a PDCCH transmission on the time location for PDCCH reception based on the PDCCH DMRS configuration.

### Thresholds

In various described embodiments, the UE compares something with a threshold (i.e., threshold value). The thresholds may be different. Some thresholds may be the same. A threshold may for instance be defined in a specification and may be specific for a synchronization frequency, frequency band, frequency range, etc. Alternatively, the UE has previously received configuration information with/been configured with a threshold in a system information or during a previous connection to the network. In yet another alternative, a threshold may be pre-configured in the UE. In yet another alternative, a threshold may be selected by the UE.

### Synchronization Raster for SC-FDE Based Cell Search and Synchronization

A synchronization signal may be transmitted on a certain frequency, e.g., the center frequency of the signal, and a certain signal bandwidth. To limit the number of center frequency candidates/hypotheses, a UE may assume that a synchronization signal is transmitted on a frequency that belongs to a synchronization raster. A synchronization raster may be a set of frequency points, e.g., corresponding to center frequencies, that may be defined in a specification or configured to a UE.

A synchronization raster may comprise a set of frequency points for a frequency band that are uniformly or non-uniformly spaced (separated) within the band. The frequency spacing may be the same in different bands, e.g., adjacent bands, or different. A UE may determine a set of synchronization raster points by using an equation, where the parameters in the equation may be defined in a specification or configured. Alternatively, the UE may determine a set of synchronization raster points from a table, that may be defined in a specification or configured to the UE.

In some cases, a synchronization signal may be transmitted with a center frequency that is offset from a synchronization raster frequency, where the offset may be configurable and/or belong a predefined set of offsets (e.g., 1, 2, 3, or 4 offsets, potentially including offset 0).

The synchronization raster and synchronization raster point concepts are used in various described embodiments. However, these terms could also be understood to represent, more generally, a particular carrier frequency, which does not necessarily lie on a synchronization raster, for example, as represented by an Absolute Radio-Frequency Channel Number (ARFCN).

The term synchronization frequency is used herein to represent a frequency, e.g., carrier frequency, on which a UE performs cell search, synchronization signal detection, synchronization signal-based measurements, synchronization, etc. A synchronization frequency may correspond to a synchronization raster point, an ARFCN, etc., e.g., as already described.

It is noted that a UE performing an operation on a synchronization frequency may include the UE performing an operation on the synchronization frequency plus/minus a frequency offset that is typically small in relation to the synchronization frequency. A synchronization signal may be received slightly off the synchronization frequency due to Doppler shifts, imperfect oscillators, etc.

### Synchronization Signals in an SC-FDE System

For PSS reception, etc., a UE may assume the following in various combinations.

One or more PSS sequences may be defined.

In some cases, the different PSS sequences may be based on different cyclic shifts of a single sequence. The different PSS sequences may be associated with different parameter values, e.g., different index values. In some cases, the parameter value may be directly used to determine the cyclic shift.

In some cases, the different PSS sequences may be generated using different initialization values, e.g., for a shift register or a pseudo-random sequence generator.

The modulated symbols may be pulse-shaped using a pulse or a filter, which may be associated with one or more parameters, such as a roll-off factor. The roll-off factor may have a value between 0 and 1, where a small roll-off factor may correspond to steeper roll off in the pulse frequency response, while resulting in higher peak-to-average-power ratio (PAPR), corresponding to a stricter roll-off. A larger roll off factor, on the other hand, would correspond to more relaxed roll-off and lower PAPR. Example pulses include raised cosine, such as the root raised cosine (RRC). In some cases, the UE may use a matched filter in its receiver, where the filter may be matched to the pulse/filter at the transmitter, e.g., an RRC filter.

The block of PSS symbols may be prepended or appended with a CP, a unique word (a predefined sequence of symbols), or zeros. In some cases, PSS symbols are not prepended or appended in such a way. Henceforth, the term CP will be used to denote a prepended or appended CP, unique word, zeros, or similar.

In some cases, a PSS may comprise multiple consecutive or non-consecutive repetitions of a PSS sequence.

The baseband symbols, including CP, if any, are up converted and transmitted on the PSS frequency, e.g., on a synchronization raster point. The PSS symbols are transmitted at a symbol rate, e.g., at a certain number of symbols per second. The bandwidth occupied by the PSS, e.g., the x dB bandwidth (where x for instance is 3, 6, etc.), may depend on multiple factors, such as the PSS symbol rate and the used roll off factor.

The notion of different PSSs (or PSSs, multiple PSSs, etc.) may refer to PSSs, e.g., PSS detection peaks, with any combination of different PSS sequences, different PSS synchronization frequencies, different PSS time offsets, different PSS frequency offsets, and/or different UE Rx beams/panels/antennas used to receive the PSSs. Similarly, the term a PSS may refer to a PSS, e.g., PSS detection peak, with such properties.

The UE may determine that PSS detection peaks that are separated by a PSS periodicity correspond to the same PSS, e.g., if the peaks correspond to the same PSS sequence, synchronization frequency, frequency offset, and/or UE Rx beam/panel/antenna, etc.

The term SSS/PBCH used herein may refer to SSS and/or PBCH. The term PBCH reception used herein may refer to PBCH reception and/or successful decoding of the PBCH.

It is noted that in SC-FDE systems, a UE receives the following synchronization signals (SS) to perform cell search: the primary synchronization signal (PSS) and secondary synchronization signal (SSS) that may comprise first SSS sequences (SSS1) and a second SSS sequences (SSS2). Unlike in NR, the reception of these signals does not necessarily have to be in consecutive time domain resources. Also, unlike NR, the SS/PBCH blocks do not necessarily have to be confined in a half-frame duration but more flexibly in a 2⁻ⁿ, n={1, 2, . . . } frame portion. For a frame portion with SS/PBCH blocks, the first block index of candidate PSS/SSS/PBCH blocks are determined according to the symbol rate of the blocks as follows, where index 0 corresponds to the first block of the first slot in the frame portion.

There are a number of possible cases for the first block of the candidate SS/PBCH blocks. For example, Case A, B, etc.: Symbol Rate 1, 2, etc.: the first block of the candidate SS/PBCH blocks have indexes of {a₁, a₂, . . . aₘ}+14n.

Each case may have sub-patterns (e.g., Case A1, Case A2, etc.), with one sub-pattern per SC-FDE frequency band. Two cases or more may have the same SS/PBCH pattern despite the different symbol rate. If the symbol rate of SS/PBCH is unknown, the UE determines the pattern case based on pre-defined cases in a specification.

Further, 5G NR signals such as SSB and TRS are based on CP-OFDM. Details specific to OFDM, such as sub-carrier spacing, FDM of SSS and PBCH as well as DMRS for demodulating PBCH, cannot be directly translated to SC-FDE since it is a pure single carrier waveform. Therefore, a new synchronization signal design/framework is required. Some aspects to consider when designing a synchronization signal is its impact on UE power consumption (due to electronic components such as ADCs). A synchronization signal bandwidth needs to take both minimum channel bandwidths and different UE capabilities into account. Moreover, different synchronization signal bandwidths may give different synchronization accuracy. For example, a NR SSB may provide coarse time synchronization and a NR tracking RS (TRS) may provide fine time synchronization. Moreover, even within a SSB signal, PSS may provide the coarse time synchronization, while SSS may provide fine time synchronization.

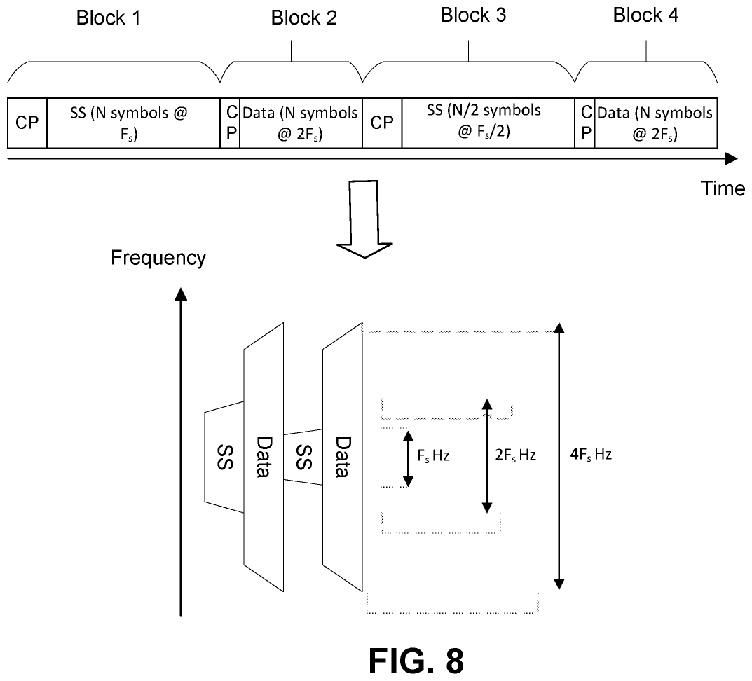

To achieve high spectrum utilization, the bandwidth of data transmissions/the data symbol rate needs to be flexible, i.e., configurable with a fine granularity. FIG. 8 illustrates an example of an SC-FDE SS with flexible bandwidth and sequence length. The SC-FDE block includes a cyclic prefix (CP) of P symbols, and data of N symbols as shown in Block 1. The symbols are transmitted at a rate Fₛ symbols per second and, therefore, the block duration is P+N/Fₛ. In the frequency domain, the SS signal bandwidth is approximately equal to 2Fₛ, where the factor 2 comes from the pulse shaping filter parameters (e.g., RRC roll off factor). Here, N data symbols may be transmitted in Block 2 (and Block 4) with half the block duration of Block 1 and double the symbol rate, which means that the data signal will occupy double the BW of Block 1. It is noted that doubling the BW typically means doubling the receiver sampling rate. It is also noted that the transmitter and receiver symbol rate (BW) should be aligned. This is a clear difference from the current NR CP-OFDM based design, in which the SCS should be aligned. Block 3 has N/2 symbols and is transmitted over the same time duration as Block 1 but with half the symbol rate.

It is understood that the UE needs to expend resources during the PSS search. The synchronization raster is typically sparse to allow for faster initial access time and less cell search effort (i.e., fewer hypothesis to test). Still, for a synchronization raster point, a significant UE effort is needed for PSS-based cell search, as will be described.

First, before PSS detection, the frame timings of the cells on the raster point are unknown. Furthermore, it is still unknown to the UE which SSBs from which cells are detectable. Hence, the UE may need to receive samples from at least a whole SSB period, which the UE may assume is 20 ms, and search for PSSs in all those samples, which is associated with a considerable UE effort.

Second, the frequency offset, e.g., due to Doppler shift, for detectable PSS(s) transmitted by a Transmission/Reception Point (TRP) are unknown. The UE may move at high speed towards a first TRP, at high speed towards a second TRP, and with zero relative speed towards a third TRP. Hence, the UE may need to perform PSS detection (in all the received samples) for various PSS frequency offset hypotheses, which further contributes to the UE effort associated with PSS search at a synchronization raster point.

The UE may use different algorithms of frequency and time offset estimation/correction. The two most prominent algorithms depend on cross-correlation and auto-correlation methods. In cross-correlation algorithm using PSS, the received signal is correlated with known patterns stored at the UE. This is more efficient for small frequency offset values (i.e., Fractional Frequency Offset (FFO)). The auto-correlation algorithm using CP auto-correlates the received signal with the corresponding CP part. The accuracy of this method can be improved by averaging the estimate of the frequency/time offsets over many OFDM symbols. For a large carrier frequency offset (CFO), the Fractional Frequency Offset (FFO) is estimated using the auto correlation method and the Integer Frequency Offset (IFO) is obtained by evaluating the shift of the received PSS. After the detection of the first PSS, subsequent PSSs are transmitted periodically within each SSB transmission.

The UE also needs to expend resources during SSS search. In NR, since SSS occupies the third OFDM symbol of the SSB block, the UE can identify SSS timing right after the detection of the first PSS. Periodic SSS transmissions are aligned with SSB timing (i.e., occur with the same periodicity). The UE uses the same frequency filter for PSS and SSS since both occupy the same frequency resources. Every 336 SSS sequences are associated with one of the three PSS sequences which yields a total of 1008 possible PCIs. The UE derives PCI group number Np from SSS and the Physical Layer identity N_{ID}⁽²⁾ VID from PSS according to N_{ID}^{Cell}=3N_{ID}⁽¹⁾+N_{ID}⁽²⁾, where N_{ID}⁽¹⁾∈{0, 1, . . . , 335} and N_{ID}⁽²⁾∈{0,1,2}.

In general, the timing and frequency offset of SSS may be largely known upon the detection of the corresponding PSS. Therefore, the UE effort for SSS detection, e.g., in terms of the number of samples the UE needs to process, is significantly less than the UE effort for PSS detection.

As will be seen, the use of “narrowband” PSS and a limited number of candidate PSS symbol rates can have certain benefits.

As described, the UE effort for PSS detection is high due to the high degree of uncertainty in the time/frequency offsets of detectable PSSs, resulting in many candidates/hypotheses. Hence, the introduction of a large number of additional candidate PSSs, e.g., in terms of PSS symbol rate, might not be feasible. A single or low number of candidate PSS symbol rates per synchronization raster point would be preferable from a UE complexity and power consumption perspective.

In case of multiple candidate PSS symbol rates, the network may select to use a lower PSS symbol rate (and bandwidth) if the total PSS beam sweeping time is reasonable, e.g., if the number of PSS beams is moderate. If the number of PSS beams is high, the network may select a higher PSS symbol rate (and bandwidth) keep down the PSS overhead.

If a single PSS symbol rate (and corresponding PSS bandwidth) needs to be specified for a raster point, it needs to fit within the channel and carrier bandwidth in all relevant scenarios. With narrowband PSS, the UE power efficiency is increased as the UE receiver in a narrowband configuration uses less power in the ADC. Moreover, the noise power will be lower due to lower receiver BW which increases PSS SNR. Consequently, a relatively narrow PSS bandwidth may be suitable.

Further, the use of wideband SSS bandwidth and PSS/SSS separation in time can also have certain benefits.

In 5G NR, SSS/PBCH is repeated in the time domain, e.g., in predefined directions (or beams). This beam “sweeping” process happens in what is known as a burst and is repeated periodically. The maximum number of beams is frequency dependent and typically increases with frequency. Wideband SSS/PBCH has the benefit of requiring less time for sweeping a certain number of beams, resulting in less resource overhead, considering the lack of frequency multiplexing in an SC-FDE system. Furthermore, a “SSS burst” that is compact in time results in shorter UE measurement windows for inter-frequency measurement, resulting in higher efficiency.

In 5G NR, the SSB typically fails to provide sufficient synchronization accuracy for the highest level of spectral efficiency, e.g., high order modulation, since its bandwidth is insufficient. Therefore, a wideband CSI-RS for tracking (TRS) needs to be transmitted in every cell with connected UEs, resulting in additional resource overhead, power consumption, etc. A wideband SSS could to a greater extent be used also for fine synchronization, reducing the need for an additional TRS.

With different PSS and SSS symbol rates (and bandwidths), it may be beneficial to separate PSS and SSS in time, e.g., to reduce the amount of symbol rate switching compared to the case with interleaved PSSs and SSSs. Instead, a number of PSS may be transmitted/received consecutively in a cell. Another benefit of separating PSS and SSS in time may be that the burst of PSS, as well as the burst of SSS, may be more compact than a burst of combined PSS+SSS. This may provide shorter measurement time for UEs that are interested in only PSS-based or only SSS-based measurement.

Further, the use of different PSS and SSS center frequencies can also have certain benefits.

In 5G NR, PSS and SSS share the same center frequency. To reduce the PSS-based cell search effort during initial access, the SSB center frequency is constrained to the sparse synchronization raster points that typically are not at the center frequency of the channel or carrier. In OFDM and NR, this is not a problem since the SSB may be located off the center of the channel/carrier. A UE that receives the whole DL carrier can still receive the off-center SSB due to the inherent FDM nature of OFDM.

A sparse synchronization raster for PSS is equally beneficial in a SC-FDE based system as in NR. However, requiring also the SSS to use the same sparse synchronization raster as center frequency may have drawbacks. For example, if a wideband SSS is used, the carrier center frequency may be too constrained. Furthermore, if SSS/PBCH is transmitted separately from the PSS, e.g., in an SSS/PBCH burst, transmitting the wideband SSS and PBCH on the same center frequency as other channels, e.g., common PDCCH, may limit the amount of center frequency switching.

### SC-FDE Synchronization Signal Framework

In some cases, e.g., standalone access, a UE may search for synchronization signals, etc., based on procedures and parameters defined in a specification. For example, the UE may search for PSS on a predefined synchronization raster. Furthermore, the UE may perform blind detection of various parameters, such as PSS, SSS, and/or PBCH parameters based on candidate values defined in a specification, for instance using various candidate values as hypotheses during signal detection/decoding.

The radio resource overhead of a narrowband synchronization signal is typically significantly higher in SC-FDE systems, since a narrowband synchronization signal prevents transmission of other signals over the whole bandwidth for the duration of the synchronization signal transmission. In contrast, in OFDM-based systems, other transmissions can be frequency multiplexed during narrowband synchronization signal transmission, thereby reducing the effective overhead of the OFDM-based synchronization signals.

An example numerical comparison assumes a similar PSS bandwidth and PSS duration for an SC-FDE based system as an OFDM-based system (as in 5G NR) and indicates that the PSS/SSS/PBCH overhead for SC-FDE in the order of 12× higher than that of the NR CP-OFDM system (e.g., 16.5% system overhead for SC-FDE vs 1.3% for CP-OFDM).

Furthermore, the long duration of a PSS/SSS/PBCH burst means that a UE needs to perform PSS detection during a longer time window, resulting in higher UE power consumption, etc. Therefore, there is a need for a flexible SC-FDE synchronization signal bandwidth design that achieves higher spectrum utilization and reduces overhead.

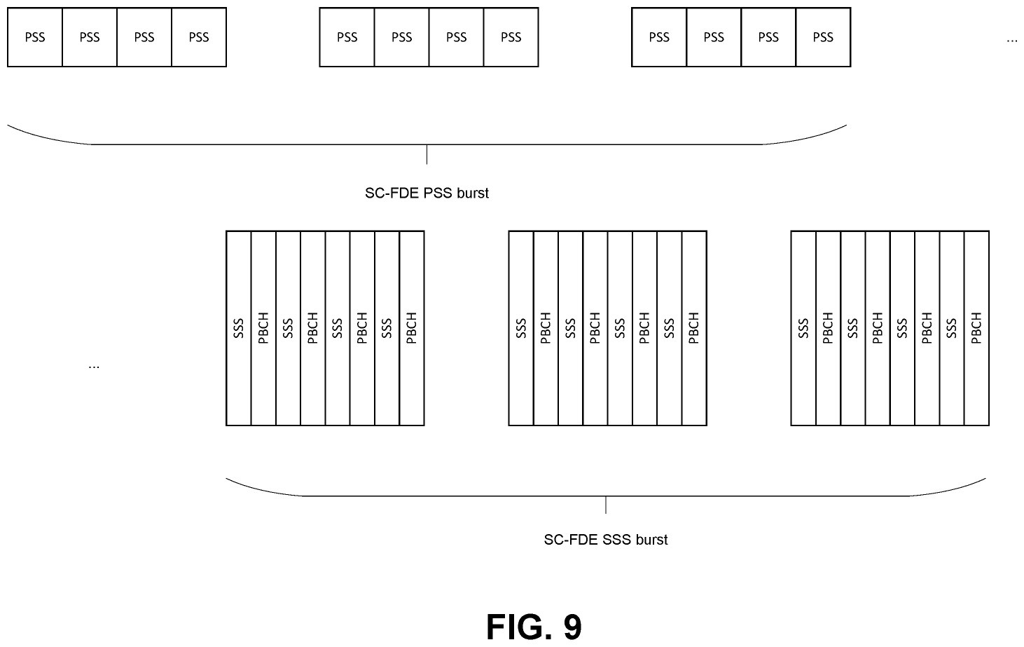

In NR, PSS, SSS and PBCH are transmitted together in an SSB with the same numerology. A SC-FDE system may instead use a narrowband PSS (with low symbol rate) and a separate wideband SSS/PBCH (with high symbol rate), as illustrated in FIG. 9. Such a design would allow the UE to consume less power for narrowband PSS based cell search due to lower sampling rate during the PSS detection during the PSS period and on multiple points on the synchronization raster and enjoy less noise due to lower receiver bandwidth. Due to wideband SSS/PBCH transmission, the SSS/PBCH overhead could be significantly reduced. The wideband SSS/PBCH would also allow for higher synchronization and measurement accuracy for SSS-based measurement.

It is typically beneficial to keep the PSS synchronization raster sparse to reduce the UE effort. However, it is also typically beneficial to transmit PSS/SSS/PBCH on the carrier center frequency to avoid frequency switching. A compromise may be to transmit the PSS on the sparse synchronization raster while transmitting the SSS/PBCH on the carrier center frequency, e.g., on a channel raster. By separating the PSS and SSS/PBCH into a PSS burst and an SSS burst, as illustrated in FIG. 9, both the amount of symbol rate switching as well as the amount of center frequency switching can be reduced, compared to if the SC-FDE PSS/SSS/PBCH are transmitted together in an “SC-FDE SSB” as in NR.

To support different SC-FDE carrier bandwidths, different SSS/PBCH symbol rates may be supported. The UE may detect the SSS/PBCH symbol rate from a set of candidate SSS/PBCH symbol rates. The UE may first detect the SSS symbol rate from a set of candidate SSS symbol rates. The UE may assume the detected SSS symbol rate when receiving and/or decoding the corresponding PBCH.

According to the present principles, a UE may, upon PSS and SSS detection, decode the PBCH, as already described. After PBCH (i.e., first channel) decoding, the UE may proceed to receive a second channel that may be a control channel (e.g., PDCCH), a data channel (e.g., PDSCH), or even a reference signal. The second channel may be broadcasted, for example transmitted on multiple time-division multiplexed (TDMed) beams, e.g., in a similar manner as SSS/PBCH in a SSS/PBCH burst. The PDCCH will be used as an example herein, without loss of generality, and may refer to PDCCH monitoring occasion(s).

Various designs of SC-FDE-based PSS, SSS, and PBCH, include a separate PSS burst and SSS/PBCH burst. In some embodiments, PBCH may be absent from an SSS/PBCH burst, but the term SSS/PBCH may still be used herein for simplicity.

In an illustrative example, consider a PSS burst, wherein the starts of subsequent PSSs are separated by a time T_{P}. In case of back-to-back PSS, T_{P} may be equal to the PSS duration, which means that the time between the end of a PSS and the start of the subsequent PSS may be zero. In case of non-back-to-back PSS, T_{P} may be larger than the PSS duration. In case of PSS sub-bursts (already described), some subsequent PSS starts in a burst are separated by T_{P}, while others are separated by more than T_{P}. In other PSS burst designs, the starts of the PSSs in a burst are separated according to another pattern, which may be predefined.

In initial access, a UE may detect a single PSS on a synchronization frequency, and the UE may not know which out of the potentially multiple time-division multiplexed PSSs that it detected. Therefore, it is beneficial if the UE procedure to determine the time domain location(s) of SSS is the same regardless of which PSS the UE detected. For instance, as already discussed, the candidate SSS(s) associated with a detected PSS (e.g., any detected PSS on a synchronization frequency) may include a set of candidate SSS time offsets, wherein a time offset (e.g., T₁) may be in relation to the timing of the detected PSS.

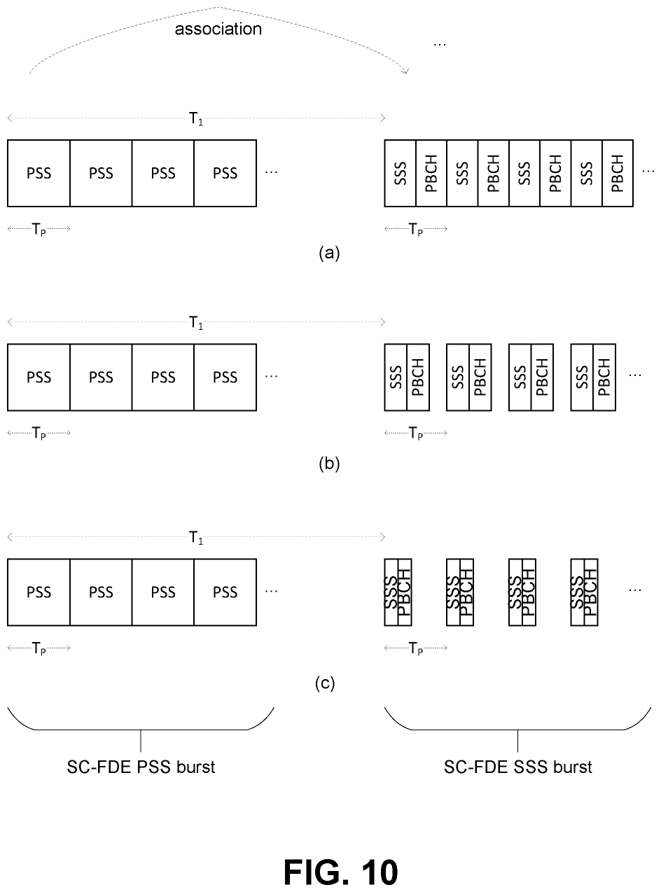

Similar to a PSS burst, SSS/PBCH may be transmitted/received in the form of an SSS/PBCH burst (or SSS burst in short). For example, with time offset T₁ between PSSs and the associated SSSs, the pattern of SSS starting times in an SSS burst may be identical to the pattern of PSS starting times in a PSS burst, as illustrated in FIGS. 10(a)-10(c).

In FIG. 10(a), the duration of SSS/PBCH is such that subsequent SSS/PBCHs are back-to-back. In FIG. 10(b), the duration of SSS/PBCH is such that subsequent SSS/PBCH are separated by a gap, i.e., they are not back-to-back. In FIG. 10(c), the duration of SSS/PBCH is even shorter than in FIG. 10(b) such that the gap between a PBCH and a subsequent SSS is even larger.

It is noted that the SSS/PBCH design in which a PBCH follows directly after its associated SSS is just an example for illustration. The opposite order as well as other designs, such as those already described, are possible alternatives. It is also noted that the network as well as the UE may switch its beam between the transmission/reception of two subsequent SSS/PBCH.

Upon successful SSS detection and/or PBCH decoding of a candidate SSS/PBCH, the UE may proceed with PDCCH reception, for instance for reception of system information. A PDCCH may be transmitted/received on one or more beams used for SSS/PBCH(s). For example, for a broadcasted PDCCH, the network may transmit PDCCH on the set of beams used to transmit SSS/PBCH.

For a PDCCH with a QCL or spatial association with a SSS/PBCH, e.g., the UE may receive the PDCCH and the associated SSS/PBCH with the same UE beam, it may be beneficial to transmit the PDCCH immediately before or after the (associated) SSS/PBCH, i.e., within the SSS burst. Thereby, no additional beam switching (at the UE and/or network side) would be required and/or less radio resources (e.g., time) would be used. A PDCCH may be QCL with the associated SSS/PBCH. As can be seen from the examples in FIG. 10, a PDCCH may fit between subsequent SSS/PBCH in some cases, e.g., as illustrated in FIG. 10(c), while not fitting between subsequent SSS/PBCH in other cases, e.g., as illustrated in FIG. 10(a). If a PDCCH doesn't fit within the SSS burst, it may need to be transmitted/received outside, e.g., before or after, the SSS burst.

### UE Determination of Time Offset

Since the payload of the MIB in the PBCH is typically minimal, the number of bits available for configuring the PDCCH may be very limited. Therefore, UE determination of certain PDCCH properties may be beneficial. According to the present principles, the UE may determine a time offset between the SSS (or the PBCH) and the second channel, which is exemplified by the PDCCH. The determination may be based on the detected PSS and the associated SSS/PBCH, for example based on a function f_{off} of PSS parameters and SSS/PBCH parameters. Example PSS parameters include PSS symbol rate, PSS duration, PSS sequence length, and time difference between two consecutive PSSs (e.g., TP), e.g., in a PSS burst.

The UE may determine a time difference between two consecutive PSSs based on other PSS parameters, such as the PSS symbol rate, PSS sequence length, etc. In case of multiple time differences between consecutive PSSs, the UE may determine and use the smallest time difference between consecutive PSSs. The time difference(s) between two consecutive PSSs may be defined in a specification, and may depend on the PSS symbol rate and/or PSS sequence length.

Example SSS/PBCH parameters include SSS/PBCH symbol rate, SSS duration, SSS plus PBCH duration, SSS sequence length, PBCH SC-FDE block length (e.g., number of symbols) or duration, SSS CP length (e.g., number of symbols) or duration, and PBCH CP length (e.g., number of symbols) or duration. Example PBCH parameters may also include information parameters carried by the PBCH and obtained by the UE upon PBCH decoding.

A PSS, SSS, PBCH parameter may have been determined by the UE, e.g., through detection, or based on other parameters.

In one example, the function f_{off} is a function of the ratio of the determined SSS/PBCH symbol rate (R_{SSS}) and the determined PSS symbol rate (R_{PSS}), f_{off}=f(R_{SSS}/R_{PSS}), e.g., f_{off}=constant*R_{SSS}/R_{PSS}. In another example, the function f_{off} is a function of the ratio of the determined SSS/PBCH symbol rate (R_{SSS}) and the determined PSS symbol rate (R_{PSS}), f_{off}=f(R_{SSS}/R_{PSS}), e.g., f_{off}=constant*R_{SSS}/R_{PSS}. In yet another example, the function f_{off} is a function of the product of the determined SSS/PBCH symbol rate (R_{SSS}) and the determined PSS time separation (T_{P}), f_{off}=f(R_{SSS}*T_{P}), e.g., f_{off}=constant*R_{SSS}*T_{P}. In yet another example, the function f_{off} is a function of the ratio of the determined PSS time separation (T_{P}) and the determined SSS/PBCH duration (T_{SSS/PBCH}), f_{off}=f(T_{P}/T_{SSS/PBCH}), e.g., f_{off}=constant*T_{P}/T_{SSS/PBCH}. In yet another example, the function f_{off} is a function of the difference of the determined PSS time separation (T_{P}) and the determined SSS/PBCH duration (T_{SSS/PBCH}), f_{off}=f(T_{P}−T_{SSS/PBCH}), e.g., f_{off}=constant*(T_{P}−T_{SSS/PBCH}). In yet another example, the function f_{off} is a function of the difference of the determined PSS time separation (T_{P}) the determined SSS/PBCH duration (T_{SSS/PBCH}), and the SSS/PBCH symbol rate, f_{off}=f(T_{P}−T_{SSS/PBCH}, R_{SSS}), e.g., f_{off}=constant*R_{SSS}*(T_{P}−T_{SSS/PBCH}). The constant in the examples may be fixed, or dependent on other parameters, such as synchronization frequency, frequency band, PSS parameters, SSS/PBCH parameters, etc. Note that the determination of the time offset, e.g., the function f_{off}, may also depend on one or more information parameters carried by the PBCH payload. Also note that SSS/PBCH duration may correspond to SSS duration, PBCH duration, or SSS plus PBCH duration.

In an example, the UE determines a first time offset if the function value is above or equal to a threshold (e.g., f_{off}≥threshold), and a second time offset if the function value is below a threshold (e.g., f_{off}≤threshold). In another example, more than two function value ranges, e.g., disjoint value ranges, are 1-to-1 mapped to different time offsets. The one or more thresholds, e.g., the thresholds that separate the function value ranges, may be defined in a specification, and may depend on the synchronization frequency.

Turning again to FIGS. 6(a)-6(c) that illustrate an example of time offset between SSS and PDCCH determined by PSS and SSS/PBCH parameters. In the figure, there is a first time offset (T_{off 1}) and a second time offset (T_{off 2}). For example, when the SSS/PBCH symbol rate is at least K times higher than the PSS symbols rate, e.g., R_{SSS}/R_{PSS}≥K, the UE may determine the time offset to the PDCCH as T_{off 1}, as in FIG. 6(c). When the SSS/PBCH symbol rate is significantly higher than the PSS symbol rate, there is typically a gap between subsequent SSS/PBCH in the SSS burst. It may be beneficial to use this gap for the associated PDCCH. Note that the back-to-back SSS, PBCH, and PDCCH, may be transmitted on the same Tx beam and received by the UE using the same Rx beam, thereby keeping down the amount of beam switching. When the SSS/PBCH symbol rate is less than K times higher than the PSS symbols rate, e.g., R_{SSS}/R_{PSS}<K, the UE may determine the time offset to the PDCCH as T_{off 2}, as in FIGS. 6(a) and 6(b).

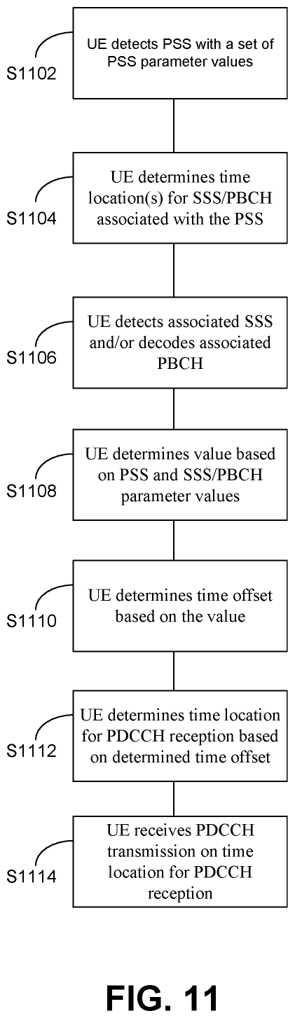

FIG. 11 illustrates a UE method for time offset determination according to an embodiment of the present principles.

In step S1102, the UE detects a PSS with a set of PSS parameter values. For example, the set of PSS parameter values includes the PSS symbol rate of the detected PSS.

In step S1104, the UE determines one or more time location(s) for SSS/PBCH associated with the detected PSS.

In step S1106, the UE detects an associated SSS and/or decodes an associated PBCH with a set of SSS/PBCH parameter values. For example, the set of SSS/PBCH parameter values comprises the SSS/PBCH symbol rate.

In step S1108, the UE determines a value of a function based on the set of PSS parameter values and the set of SSS/PBCH parameter values. For example, the function value is determined as the ratio between the SSS/PBCH symbol rate and the PSS symbol rate.

In step S1110, the UE determines a time offset based on the function value. For example, the UE determines a first time offset if the function value is above or equal to a threshold, and a second time offset if the function value is below the threshold.

In step S1112, the UE determines a time location for PDCCH reception based on the determined time offset. For example, a time location for PDCCH reception is determined as the time location of the detected SSS plus the time offset, e.g., the first time offset. For example, a time location for PDCCH reception is determined as the beginning of a radio frame plus the time offset, e.g., the second time offset. The determination of time offset, e.g., a part of the time offset, may also depend on a parameter in the decoded PBCH, e.g., a MIB parameter.

In step S1114, the UE receives a PDCCH transmission on the time location for PDCCH reception.

### UE Determination of Number of PDCCH Symbols

The time duration of a PDCCH may depend on the PDCCH symbol rate, which may advantageously be the same as the SSS/PBCH rate, but also on the number of PDCCH symbols. The number of PDCCH symbols may correspond to the SC-FDE block size (including or excluding the CP) of the block that includes the PDCCH, etc. In some embodiments, the PDCCH symbol rate may be different from the SSS/PBCH rate, and indicated in the PBCH (e.g., in the MIB). The number of PDCCH symbols may be variable. In some embodiments, the number of PDCCH symbols is indicated to the UE in the PBCH. In some embodiments, the UE may determine the number of PDCCH symbols based on the number of gap symbols between subsequent SSS/PBCH. In some embodiments, a minimum number of PDCCH symbols is indicated to the UE in the PBCH, while the UE may extend the number of PDCCH symbols to a number greater than the minimum, for example to better utilize the gap symbols.

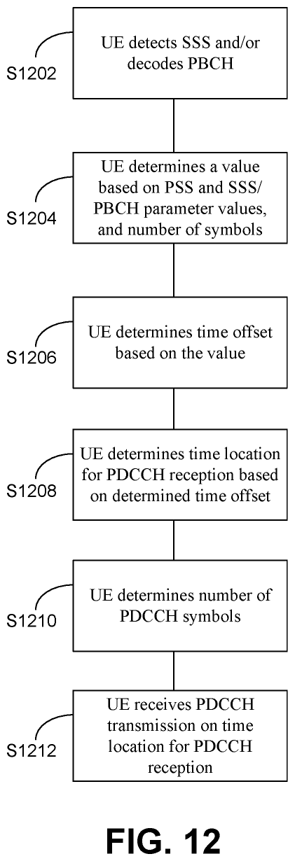

FIG. 12 illustrates a UE method for determination of a number of PDCCH symbols according to an embodiment of the present principles.

In step S1202, the UE detects an SSS and/or decodes a PBCH, which may be associated with a detected PSS, with a set of SSS/PBCH parameter values, wherein the decoded PBCH comprises an indication of a number of PDCCH symbols. The set of SSS/PBCH parameter values may include the SSS/PBCH symbol rate. The PBCH may indicate a minimum number of PDCCH symbols (that, alternatively, may be predetermined). The PBCH may indicate a maximum number of PDCCH symbols (that, alternatively, may be predetermined). The PBCH may indicate a number of PDCCH symbols (that, alternatively, may be predetermined or determined by the UE). The PBCH may indicate a (minimum) number of PDCCH candidates, one or more aggregation level(s), etc., based on which the UE may determine a minimum number of PDCCH symbols.

In step S1204, the UE determines a value of a function based on the set of PSS parameter values, the set of SSS/PBCH parameter values, and the indicated number of PDCCH symbols. The function value may be determined as the difference between the separation in time between two consecutive PSSs (e.g., T_{P}) and the sum of the SSS/PBCH duration and the PDCCH duration, wherein the UE may determine the PDCCH duration based on the (minimum/indicated/specified) number of PDCCH symbols and the PDCCH symbol rate.

In step S1206, the UE determines a time offset based on the function value. The UE may for example determine a first time offset if the function value is above or equal to a threshold (e.g., zero), and a second time offset if the function value is below the threshold.

In step S1208, the UE determines a time location for PDCCH reception based on the time location of the detected/decoded SSS/PBCH and the determined time offset. The time location for PDCCH reception may be determined as the time location of the detected SSS plus the time offset.

In step S1210, the UE determines the number of PDCCH symbols. The UE may determine a number between (or equal to) a minimum number and a maximum number.

If the UE determined a PDCCH time location within an SSS burst, e.g., corresponding to the first time offset, the UE may determine the number of PDCCH symbols based on the number of symbols in the gap between two subsequent SSS/PBCH. For example, the UE may determine the number of PDCCH symbols as the highest number of PDCCH symbols that fits within the gap, where in the highest number also may need to fulfil other constraints such as the maximum number or a set of supported numbers, e.g., due to DFT size constraints (see below). If different subsequent (nominal, e.g., not necessarily transmitted) SSS/PBCH may have different number of symbols in the gap, e.g., if SSS/PBCH may be non-uniformly distributed in the SSS burst, the UE may use the minimum gap. Alternative, the UE may use the actual gap between subsequent (nominal) SSS/PBCH, which may result in different number of symbols for PDCCH that correspond to different SSS/PBCH.

If the UE determined a PDCCH time location not within an SSS burst, e.g., corresponding to the second time offset, the UE may determine the number of symbols based on the time difference between two subsequent SSSs, which may be the same as the time difference between two subsequent PSSs. This time difference may also be called a gap. For example, the UE may determine the number of PDCCH symbols as the highest number of PDCCH symbols that fits within the time different, where in the highest number also may need to fulfil other constraints such as the maximum number or a set of supported numbers, e.g., due to DFT size constraints (see below).

In step S1212, the UE receives a PDCCH transmission on the time location for PDCCH reception based on the number of PDCCH symbols.

A PDCCH may be included in a SC-FDE block with N symbols and a CP with NCP symbols. In case a minimum number of PDCCH symbols is M, the UE may determine M from a configured value or from an indication in PBCH. A limited set of DFT sizes may be supported by the UE. Hence, a UE may not select an arbitrary N to fill the available number of symbols G, wherein the available number of symbols may be the number of symbols in a gap or the number of symbols between two consecutive PDCCHs, e.g., corresponding to the T_{P}. Instead, the UE may select the largest supported value of N such that the number of remaining symbols (e.g., G−N) is at least a minimum CP length, wherein the UE may determine the minimum CP length from a specification and/or based on the synchronization frequency, the PSS symbol rate, the SSS symbol rate, the SSS CP, the PBCH CP, and/or a CP indication in the decoded PBCH. Upon selection of N, the UE may select the number of CP symbols for the SC-FDE block that includes the PDCCH as N_{CP}=G−N. However, the number of CP symbols may be upper bounded by N, e.g., N_{CP}=min (G−N, N). If the determined CP and DFT size does not fill the gap, the SC-FDE block carrying the PDCCH may be placed back-to-back with the associated SSS/PBCH.

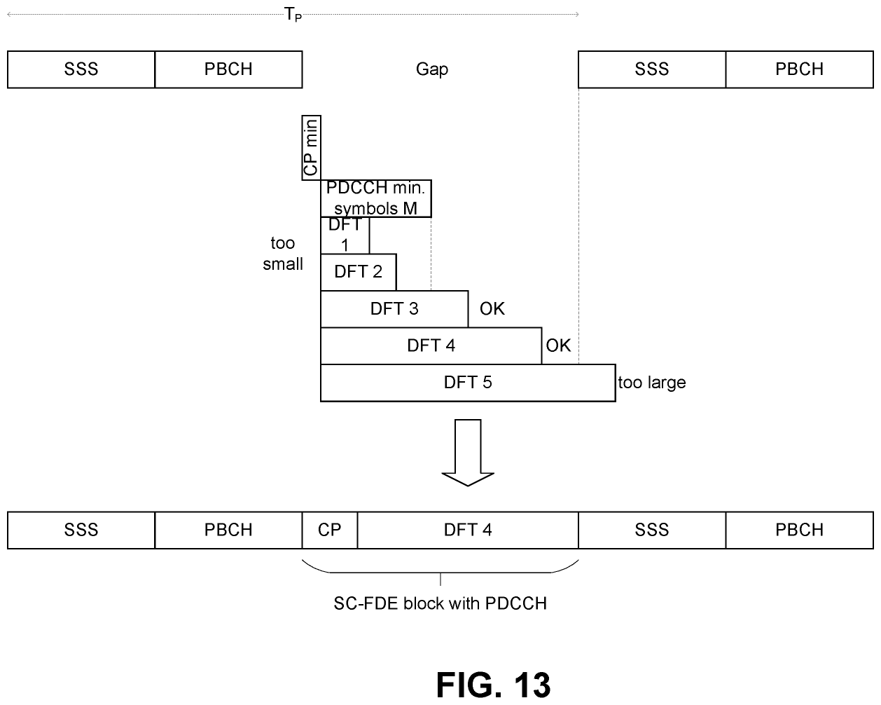

FIG. 13 illustrates UE determination of the number of PDCCH symbols as well as a CP length, based on the minimum CP length, the minimum number of PDCCH symbols, the gap duration, and the PDCCH symbol rate according to a first embodiment of the present principles. In this case, the gap duration is based on duration between two subsequent SSS/PBCH. The number of PDCCH symbols may be constrained by a set of supported DFT sizes (DFT 1, DFT 2, etc.). The UE determines the largest DFT size such that also at least the minimum CP length can be accommodated in the gap. In this example, it's DFT size 4. Following the selection of DFT 4, the UE may determine the CP length as the largest CP length such that the resulting SC-FDE block fits within the gap.

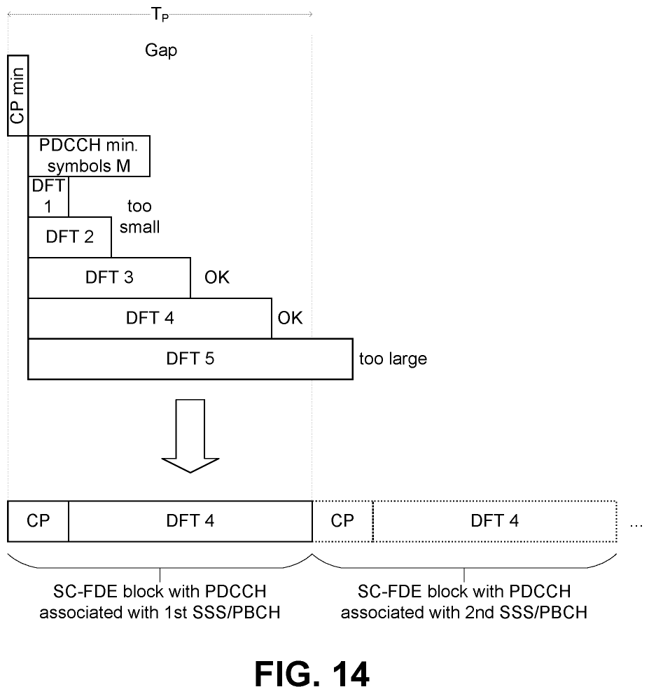

FIG. 14 illustrates UE determination of the number of PDCCH symbols as well as a CP length, based on the minimum CP length, the minimum number of PDCCH symbols, the gap duration, and the PDCCH symbol rate according to a first embodiment of the present principles. In this case, the gap duration is based on the time difference between the starting time of two subsequent PDCCHs, e.g., PDCCHs associated with subsequent SSS/PBCH. This situation may occur for instance if the PDCCH are not multiplexed within an SSS burst, e.g., as in FIGS. 6(a) and 6(b).

The UE may apply PDCCH rate matching based on the number of PDCCH symbols. The minimum number of PDCCH symbols may correspond to the highest supported PDCCH rate matching, e.g., given other parameters such as aggregation level(s), number of PDCCH candidates, etc. The minimum number of PDCCH symbols may correspond to a minimum number of PDCCH candidates and/or lower aggregation level(s). The UE may receive an indication of PDCCH aggregation level(s) or minimum PDCCH aggregation level, e.g., in MIB. The UE may receive an indication of number of PDCCH candidate(s) or minimum number of PDCCH candidates, e.g., in MIB. The UE may determine a minimum number of PDCCH symbols (M) based on the indicated or specified (minimum) PDCCH aggregation level and/or the indicated or specified (minimum) number of PDCCH candidates.

### UE Determination of PDCCH Repetition

In some cases, the UE may determine that a PDCCH, e.g., a PDCCH candidate, may be repeated across multiple SSS bursts, e.g., multiple consecutive SSS bursts. The PDCCH occasions may occur at the same location within the multiple SSS bursts, e.g., following/preceding the same corresponding SSS/PBCH, for instance the SSS/PBCH in the burst corresponding to the same SSS/PBCH index.

The UE may determine that PDCCH is multiplexed within an SSS burst, even if the corresponding gap duration between consecutive SSS/PBCH is not large enough to contain an SC-FDE block with a number of PDCCH symbols. The UE may determine a number of PDCCH repetitions such that the number of PDCCH symbols combined across PDCCH repetitions (occasions) is at least the required number of symbols.

### UE Determination of PDCCH Symbol Rate

The PDCCH symbol rate may be the same as the SSS symbol rate and/or PBCH symbol rate. Alternatively, the PDCCH symbol rate may be different from the SSS/PBCH symbol rate.

The PDCCH symbol rate may depend on the PDCCH time offset. For example, for a first time offset, the UE may use a first PDCCH symbol rate, and for a second time offset, the UE may use a second PDCCH symbol rate. For instance, it may be beneficial to use the SSS/PBCH symbol rate if the PDCCH is received back-to-back with the associated SSS/PBCH. In other words, the UE may use the same symbol rate for PDCCH reception as for SSS/PBCH reception when the PDCCH is multiplexed with the SSS/PBCH, e.g., in the SSS burst. On the other hand, the UE may use a symbol rate different from the SSS/PBCH when the PDCCH is not multiplexed with the SSS/PBCH, e.g., outside the SSS burst.

A PDCCH symbol rate may be indicated by the PBCH (e.g., in the MIB), e.g., the PDCCH symbol rate that is different from the SSS/PBCH symbol rate. For example, for PDCCH, the UE uses the SSS/PBCH symbol rate if the PDCCH is multiplexed in the SSS burst, while using an indicated symbol rate if the PDCCH is not multiplexed in the SSS burst. The indication values may correspond to symbol rates that are defined in a specification. The indication values may correspond to different symbol rates in different synchronization frequencies or frequency bands/ranges.

### UE Determination of DMRS-Less PDCCH

The UE reception of data/information symbols, e.g., in PBCH or PDCCH, typically requires DMRS for channel estimation, wherein DMRS includes known symbols. As the radio channel is typically fading in time, the DMRS need to be received close in time with the data. Furthermore, the DMRS and data symbols need to be transmitted and received in the same way, e.g., using the same antennas, beamforming, etc.

For SSS/PBCH, the SSS is typically transmitted right before or after the PBCH. Hence, the SSS may serve as DMRS for the PBCH. Thereby, additional DMRS symbols may not need to be multiplexed with the PBCH. Alternative, a reduced amount of DMRS may be multiplexed with the PBCH.

For PDCCH in legacy systems, DMRS are typically multiplexed with the PDCCH information symbols, such that the PDCCH reception may be self-contained.

However, for PDCCH multiplexed in an SSS burst, e.g., as illustrated in FIG. 6(c), the associated SSS may provide sufficient channel estimation performance at the UE, an PDCCH DMRS can be omitted or reduced. Thereby, more PDCCH information symbols can be received within the same time duration, and a lower coding rate can be used.

If the PDCCH is multiplexed outside SSS bursts, e.g., as illustrated in FIGS. 6(b) and 6(c), the associated SSS may not provide relevant channel estimates for PDCCH reception. Therefore, separate DMRS received together with the PDCCH may be needed.

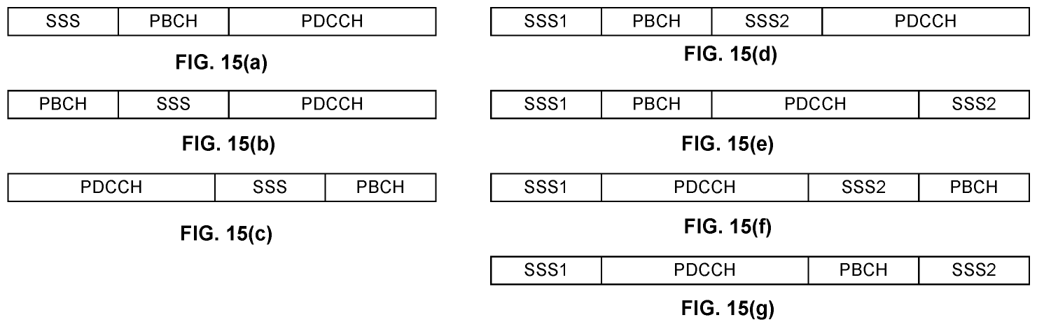

FIGS. 15(a)-15(g) illustrate examples multiplexing of PDCCH together with associated SSS/PBCH according to the present principles. It is noted that, if PDCCH is multiplexed together with an associated SSS/PBCH, e.g., in an SSS burst, the UE may also use the PBCH DMRS for PDCCH reception, e.g., in addition to the SSS. In some cases, the PBCH does not come with PBCH DMRS. Instead, SSS may be used as DMRS also for PBCH. Hence, it may be beneficial if the UE receives the SSS between the PBCH and PDCCH, as illustrated in FIGS. 15(b)-15(c), (instead of before, as illustrated in FIG. 15(a)), thereby increasing the correlation between the SSS and both PBCH and PDCCH. As discussed above, SSS may comprise two parts (SSS1 and SSS2) in various designs. FIGS. 15(d)-15(g) illustrate options for multiplexing PDCCH with SSS/PBCH, wherein PBCH and PDCCH are adjacent to an SSS (part) in each option.

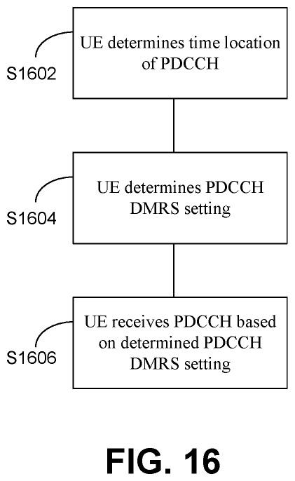

FIG. 16 illustrates an example UE method for determination of DMRS-less PDCCH.

In step S1602, the UE determines a time location of a PDCCH, e.g., based on PSS, SSS (may include SSS1/2), and/or PBCH parameters (see various methods herein).

In step S1604, the UE determines a PDCCH DMRS setting.

In case the time location of the PDCCH is adjacent to SSS/PBCH, the UE determines as PDCCH DMRS setting a first DMRS setting that may correspond to no PDCCH DMRS or reduced PDCCH DMRS (compared to the second DMRS setting). The SSS and/or PBCH DMRS may be applicable to PDCCH reception.

In case the time location of the PDCCH is not adjacent to SSS/PBCH, the UE determines as PDCCH DMRS setting a second DMRS setting that may include DMRS transmitted together with the PDCCH.

In step S1606, the UE receives the PDCCH based on the determined PDCCH DMRS setting.

The determination to use the first setting may also depend on the PDCCH symbol rate. For example, the first DMRS setting may be determined only if the PDCCH symbol rate is the same as the SSS/PBCH symbol rate.

### UE Determination of PDCCH Presence Based on PBCH Absence

In some cases, the PBCH periodicity is longer than the SSS periodicity, for instance a multiple of the SSS periodicity. The PBCH may be present, e.g., may be received by the UE, every Bth SSS burst. PBCH presence/absence in SSS bursts need not be periodic. Instead, presence/absence may be detectable by the UE, e.g., based on properties of PSS/SSS.

Two subsequent SSS in an SSS burst may be separated by a certain spacing, e.g., T_{P}. As described above, the gap between two subsequent SSS/PBCH may be too short for a PDCCH. However, if PBCH is absent, the gap may be sufficient. Therefore, it may be feasible and beneficial to multiplex PDCCH in an SSS burst if PBCH is absent in the burst, and not multiplex PDCCH in the SSS burst if PBCH is present. If the PDCCH is not multiplexed, it may be simply omitted. Alternatively, the PDCCH may be moved outside the SSS burst, e.g., as illustrated in FIGS. 6(a) and 6(b). It is noted that a PDCCH may be multiplexed before and/or after an associated SSS. In other words, the determination of time offset may be based on SSS bursts with absent PBCH. It is also noted that the UE determination of number of PDCCH symbols, the UE determination of PDCCH repetition, DMRS-less PDCCH, etc., may be applicable also in the case of PBCH absence in an SSS burst.

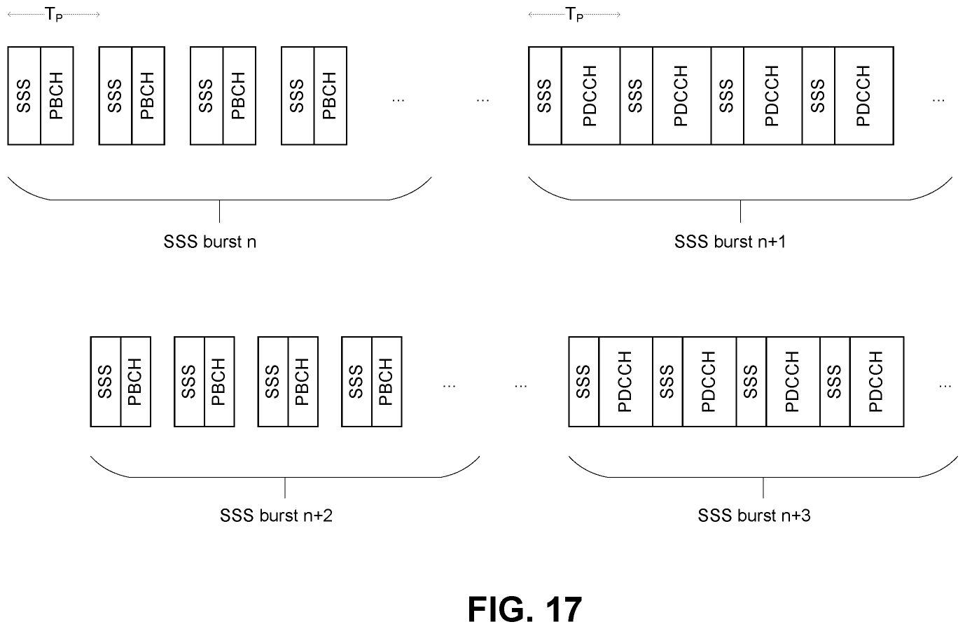

FIG. 17 illustrates multiplexing of PDCCH in an SSS burst based on PBCH absence according to an embodiment of the present principles. PBCH is present in bursts n and n+2, e.g., the PBCH to SSS periodicity ratio B=2. PBCH is absent in SSS bursts n+1, n+3. Instead of PBCH, a PDCCH is multiplexed after the associated SSS.

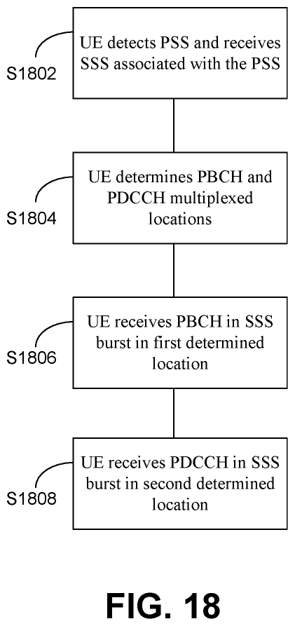

FIG. 18 illustrates a UE method for determination of PDCCH presence based on PBCH absence according to an embodiment of the present principles.

In step S1802, the UE detects a PSS and receives an SSS associated with the PSS.

In step S1804, based on the properties of the PSS and/or the SSS, the UE determines that PBCH is multiplexed in a first set of SSS bursts and that PDCCH may be multiplexed in a second set of SSS bursts.

In step S1806, the UE receives a PBCH in an SSS burst from the first set.

In step S1808, the UE receives a PDCCH in an SSS burst from the second set.

In an alternative solution, the UE receives a PBCH, and based on a received PBCH determines that the PBCH is multiplexed in a first set of SSS bursts and that the PDCCH may be multiplexed in a second set of SSS bursts. For example, the determination may be based on that the UE successfully received a PBCH in an SSS burst from the first set and unsuccessfully received a PBCH in a SSS burst from the second set. In an alternative, information carried in a PBCH may indicate to the UE that the PBCH is multiplexed in a first set of SSS bursts and that the PDCCH may be multiplexed in a second set of SSS bursts.

As described herein, a UE may detect, measure, and/or synchronize to synchronization signal(s) (e.g., PSS and/or SSS), and/or receive and successfully decode PBCH. The UE may monitor PDCCH and subsequently receive a PDSCH scheduled by a received PDCCH, e.g., for reception of system information, paging, random access response, random access message 4, etc. The UE may transmit on one or more PRACH, based on the time—and/or frequency synchronization (e.g., incl. DL frame timing) determined from the received synchronization signal(s), on time—and/or frequency resources determined from a specification and/or a configuration obtained in a received system information message. The UE may also transmit on a PUSCH, e.g., scheduled by a received PDCCH, e.g., a random access message 3, random access message A, etc.

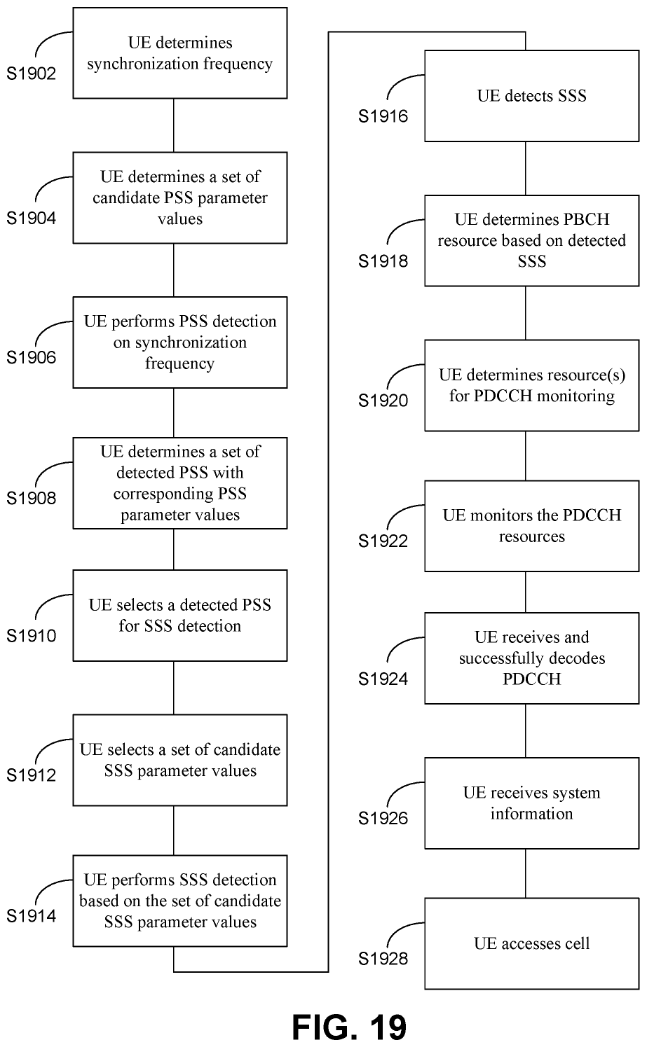

FIG. 19 illustrates a UE method according to an embodiment of the present principles.

In step S1902, the UE determines a synchronization frequency.

In step S1904, the UE determines a set of candidate PSS parameter values. Example candidate PSS parameter values include candidate PSS sequences, candidate PSS symbol rate, and PSS periodicity.

In step S1906, the UE performs PSS detection on the synchronization frequency, based on the set of candidate PSS parameter values.

In step S1908, the UE determines a set of detected PSS with corresponding PSS parameter values, based on the PSS detection.

In step S1910, the UE selects a detected PSS for SSS detection.

In step S1912, the UE selects a set of candidate SSS parameter values. The set may be based on the PSS parameter values of the (selected) detected PSS. SSS parameters may include one or more of symbol rate, center frequency, time-domain location, QCL relation with the detected PSS, and sequence. A candidate value of a first SSS parameter may be associated with a candidate value of a second SSS parameter, etc. For instance, a first SSS symbol rate may be associated with a first SSS time-location.

In step S1914, the UE performs SSS detection based on the set of candidate SSS parameter values.

In step S1916, the UE detects a SSS based on the SSS detection, with corresponding SSS parameter values.

In step S1918, the UE determines a PBCH resource based on the detected SSS. The UE may determine a subset of SSS occasions with PBCH resources. The UE decodes a PBCH based on the determined PBCH resource.

In step S1920, based on the detected PSS, SSS, and decoded PBCH, the UE determines resource(s) for PDCCH monitoring. In one example, the UE determines resource(s) based on the ratio between the symbol rate of the detected SSS and the symbol rate of the associated detected PSS. In another example, the UE first determines a time difference between consecutive PSSs, e.g., based on the PSS symbol rate. The UE then determines resource(s) based on the difference between the determined PSS time difference and a PDCCH duration. In another example, the UE similarly also determines the PDCCH CP duration. In another example, the UE determines a PDCCH DMRS configuration, based on determined resource(s) for PDCCH monitoring. For instance, if a PDCCH resource is adjacent to an SSS, the UE determines a DMRS configuration without DMRS. In another example, the UE determines PDCCH resources in SSS occasions without PBCH resources.

In step S1922, the UE monitors the PDCCH resources.

In step S1924, the UE receives and successfully decodes a PDCCH transmission on a PDCCH resource.

In step S1926, based on information in the decoded PDCCH transmission, the UE obtains system information in a PDSCH.

In step S1928, the UE accesses the cell, based on the system information, e.g., by performing random access.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency trade-offs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method at a wireless transmit/receive unit (WTRU), the method comprising:
detecting, based on at least one received signal, a primary synchronization signal associated with a set of primary synchronization signal parameters;
detecting, based on the at least one received signal, a secondary synchronization signal associated with a set of secondary synchronization signal parameters;
determining a time offset of a control channel signal based on at least one of the set of primary synchronization signal parameters and the set of secondary synchronization signal parameters;
determining a time location for reception of the control channel signal based on the time offset; and
receiving a control channel signal based on the time location.

2. The method of claim 1, further comprising determining a size of a block of symbols that includes the control channel, and wherein receiving the control channel transmission on the time location for control channel reception is based on the size of the block of symbols.

3. The method of claim 1, further comprising determining a control channel demodulation reference signal configuration based on the control channel time offset, and wherein receiving the control channel transmission on the time location for control channel reception is based on the control channel demodulation reference signal configuration.

4. The method of claim 1, wherein the set of primary synchronization signal parameters includes at least one of primary synchronization signal symbol rate, primary synchronization signal duration, primary synchronization signal duration, and a time difference between two consecutive primary synchronization signals.

5. The method of claim 1, wherein the set of secondary synchronization signal parameters includes at least one of secondary synchronization signal symbol rate, secondary synchronization signal duration, secondary synchronization signal sequence length, and secondary synchronization signal cyclic prefix length.

6. The method of claim 1, wherein the time offset of the control channel is based on a function value determined using a parameter of the set of primary signal parameters and a parameter of the set of secondary signal parameters, and wherein determining the time offset of the control channel comprises selecting a first time offset in case the value is above a given value and selecting a second time offset in case the value is below the given value.

7. The method of claim 1, wherein the time offset is based on a ratio between a secondary synchronization signal symbol rate and a primary synchronization signal symbol rate.

8. The method of claim 1, wherein the time offset is based on a product between a secondary synchronization signal symbol rate and a time separation between consecutive primary synchronization signals.

9. The method of claim 1, wherein the time offset is based on a ratio between a time separation between consecutive primary synchronization signals and a time duration of the secondary synchronization signal.

10. The method of claim 1, wherein the time offset is based on a difference between a time separation between consecutive primary synchronization signals and a time duration of the secondary synchronization signal.

11. The method of claim 1, further comprising:
receiving, based on the set of secondary synchronization signal parameters, a physical broadcast channel; and
decoding the physical broadcast channel.

12. The method of claim 11, wherein the time offset is based on a difference between a time separation between consecutive primary synchronization signals and a time duration of the secondary synchronization signal and the physical broadcast channel.

13. The method of claim 2, wherein the size of the block of symbols is determined as a number of symbols between consecutive secondary synchronization signals.

14. The method of claim 1, wherein the time location for control channel reception is determined as a detected secondary synchronization signal time location plus the time offset.

15. The method of claim 1, wherein the time location for control channel reception is determined as a time of a beginning of a radio frame plus the time offset.

16. The method of claim 1, wherein determining a time offset of a control channel signal based on at least one of the set of primary synchronization signal parameters and the set of secondary synchronization signal parameters comprises determining a time offset of a control channel signal based on the set of primary synchronization signal parameters and the set of secondary synchronization signal parameters.

17. A wireless transfer/receive unit (WTRU) comprising at least one processor configured to:
detect, based on at least one received signal, a primary synchronization signal associated with a set of primary synchronization signal parameters;
detect, based on the at least one received signal, a secondary synchronization signal associated with a set of secondary synchronization signal parameters;
determine a time offset of a control channel signal based on at least one of the set of primary synchronization signal parameters and the set of secondary synchronization signal parameters;
determine a time location for reception of the control channel signal based on the time offset; and
receive a control channel signal based on the time location.

18. The WTRU of claim 17, wherein the at least one processor is further configured to determine a size of a block of symbols that includes the control channel, and wherein receive the control channel transmission on the time location for control channel reception is based on the size of the block of symbols.

19. The WTRU of claim 17, further wherein the at least one processor is further configured to determine a control channel demodulation reference signal configuration based on the control channel time offset, and wherein receive the control channel transmission on the time location for control channel reception is based on the control channel demodulation reference signal configuration.

20. The WTRU of claim 17, wherein the set of primary synchronization signal parameters includes at least one of primary synchronization signal symbol rate, primary synchronization signal duration, primary synchronization signal duration, and a time difference between two consecutive primary synchronization signals.

21. The WTRU of claim 17, wherein the set of secondary synchronization signal parameters includes at least one of secondary synchronization signal symbol rate, secondary synchronization signal duration, secondary synchronization signal sequence length, and secondary synchronization signal cyclic prefix length.

22. The WTRU of claim 17, wherein the time offset of the control channel is based on a function value determined using a parameter of the set of primary signal parameters and a parameter of the set of secondary signal parameters, and wherein the at least one processor being configured to determine the time offset of the control channel comprises the at least one processor being configured to select a first time offset in case the value is above a given value and selecting a second time offset in case the value is below the given value.

23. The WTRU of claim 17, wherein the time offset is based on a ratio between a secondary synchronization signal symbol rate and a primary synchronization signal symbol rate.

24. The WTRU of claim 17, wherein the time offset is based on a product between a secondary synchronization signal symbol rate and a time separation between consecutive primary synchronization signals.

25. The WTRU of claim 17, wherein the time offset is based on a ratio between a time separation between consecutive primary synchronization signals and a time duration of the secondary synchronization signal.

26. The WTRU of claim 17, wherein the time offset is based on a difference between a time separation between consecutive primary synchronization signals and a time duration of the secondary synchronization signal.

27. The WTRU of claim 17, wherein the at least one processor is further configured to:
receive, based on the set of secondary synchronization signal parameters, a physical broadcast channel; and
decode the physical broadcast channel.

28. The WTRU of claim 17, wherein the time offset is based on a difference between a time separation between consecutive primary synchronization signals and a time duration of the secondary synchronization signal and the physical broadcast channel.

29. The WTRU of claim 18, wherein the size of the block of symbols is determined as a number of symbols between consecutive secondary synchronization signals.

30. The WTRU of claim 17, wherein the time location for control channel reception is determined as a detected secondary synchronization signal time location plus the time offset.

31. The WTRU of claim 17, wherein the time location for control channel reception is determined as a time of a beginning of a radio frame plus the time offset.

32. The WTRU of claim 17, wherein the at least one processor being configured to determine a time offset of a control channel signal based on at least one of the set of primary synchronization signal parameters and the set of secondary synchronization signal parameters comprises the at least one processor being configured to determine a time offset of a control channel signal based on the set of primary synchronization signal parameters and the set of secondary synchronization signal parameters.
